(19) United States
(12) Patent Application Publication
(10) Pub. No.: US 2014/0297697 A1
(43) Pub. Date: Oct. 2, 2014

(54) DATABASE SYSTEM AND DATABASE MANAGEMENT METHOD

(71) Applicants: Satoru Watanabe, Yokohama (JP); Junji Ogawa, Sagamihara (JP)

(72) Inventors: Satoru Watanabe, Yokohama (JP); Junji Ogawa, Sagamihara (JP)

(73) Assignee: HITACHI, LTD., Tokyo (JP)

(21) Appl. No.: 13/576,365

(22) PCT Filed: Jul. 11, 2012
(86) PCT No.: PCT/JP2012/004482

§ 371 Date: Jul. 31, 2012

(51) Int. Cl. G06F 3/06

(52) U.S. Cl. CPC G06F 3/061; G06F 3/067; G06F 3/0655
USPC 707/823

(57) ABSTRACT

The method includes (A) acquiring storage location information that can identify a volume that stores data and access type information, (B) acquiring volume management information that can identify the storage unit that stores the volume, (C) identifying the volume of data to be accessed, identifying the storage unit storing the volume, and identifying the storage method of the storage unit, (D) identifying the type of access to the data to be accessed, (E) determining whether the data needs to be moved to another storage unit of a different storage method based on the storage method and the type of access, and (F) giving an indication of moving the data if it is determined that the data needs to be moved in (E).

### TECHNICAL FIELD

The present invention relates to database management.

### BACKGROUND ART

There are currently many information systems that use a database management system (hereinafter, denoted as DBMS). A DBMS is responsible for a series of processing and management associated with data, playing an important role in an information system. Since the processing performance of the DBMS has significant influence on that of the information system, it is a crucial issue to improve the processing performance of the DBMS.

One of main functions of the DBMS is to guarantee data persistence. For guarantee of data persistence, the DBMS stores data to be managed with a database (hereinafter, “DB data”) in non-volatile storage units. A commonly used non-volatile storage unit is a hard disk drive (hereinafter “HDD”), which is based on a magnetic storage method. When HDDs are used to store DB data, a DBMS seeks to improve the performance of the information system by appropriately selecting an HDD into which DB data will be placed.

For example, Patent Literature 1 describes a technique relating to a control method for a storage subsystem for connection to one or more computers, the subsystem including means for acquiring information on usage of storage units, and means for associating logical storage areas to/from which the computer(s) reads/writes with physical storage areas (first physical storage areas) of the storage units. This technique classifies the storage units into multiple sets or classes, and configures attributes for each of the classes. The technique then determines relocation classes (second physical areas) that are appropriate for the logical storage areas from among the classes, based on usage information for the storage units of the computer(s) and the class attributes configured for the storage units.

Information system performance could also be improved by appropriate selection of the order of access to HDDs. For instance, Patent Literature 2 discloses a storage apparatus that derives a processing execution schedule for queries to a database of a DBMS and determines the order of access to storage units in accordance with the schedule.

### CITATION LIST

### Patent Literature

PTL 1: Japanese Patent Laid-Open No. 2001-67187
PTL 1: Japanese Patent Laid-Open No. 2003-150419

### SUMMARY OF INVENTION

### Technical Problem

While the HDD has been the mainstream non-volatile storage for DB data, semiconductor storage units using electronic storage methods, such as SSD (Solid State Drive), have recently come to be used.

A magnetic storage unit and a semiconductor storage unit are different in I/O processing performance due to the difference of storage methods. For example, by the nature of its storage method, the magnetic storage unit has low processing performance for random Input/Output (I/O) compared to the semiconductor storage unit. Meanwhile, the magnetic storage unit is characterized by being less expensive than the semiconductor storage unit. Consequently, sometimes magnetic and semiconductor storage units are used in combination as storage devices.

With such a DBMS that uses both magnetic and semiconductor storage units as storage units, it is desirable to move data between storage units (hereinafter, to relocate data) and/or appropriately change the order of access to DB data on the basis of the I/O processing performance of the storage units in order to improve the cost performance of the information system.

The technique disclosed by Patent Literature 1 cannot relocate data according to storage method because it does not differentiate storage methods. The technique disclosed by Patent Literature 2 is intended for controlling the order of access to storage units based on a processing execution schedule, being unable to achieve efficient access to DB data stored in storage units depending on the storage methods of the storage units.

### Solution to Problem

A database management method according to an aspect of the present invention is implemented in a database system including: a storage apparatus including a plurality of types of storage units that use different storage methods for storing data; a computer configured to manage a database by storing data to be managed with the database in storage areas of the storage units of the storage apparatus; and a control server coupled to the storage apparatus and the computer.

A storage device of the control server has stored therein storage method information that identifies the storage methods of the storage units of the storage apparatus.

The database management method includes: (A) acquiring, from the computer, volume identifying information capable of identifying a volume that stores database data to be accessed during processing for a query request to the database, and access type information that is capable of identifying a type of access to the data; (B) acquiring, from the storage apparatus, volume management information that is capable of identifying the storage unit that stores the volume; (C) identifying the volume of the data that is to be accessed during processing for the query request based on the volume identifying information, identifying the storage unit that stores the identified volume based on the volume management information, and identifying the storage method of the storage unit based on the storage method information; (D) identifying the type of access to the data that is to be accessed during processing for the query request, based on the access type information; (E) determining whether the data needs to be moved to another storage unit of a different storage method, based on the storage method identified in (C) and the type of access identified in (D); and (F) giving an indication of moving the data to another storage unit of a different storage method if it is determined in (E) that the data needs to be moved to another storage unit of a different storage method.

### Advantageous Effect of Invention

The present invention enables appropriate determination of at least one of DB data placement and the mode of access to DB data for the purpose of gaining good performance of a database system with a storage apparatus that includes both magnetic and semiconductor storage units.

### BRIEF DESCRIPTION OF DRAWINGS

FIG. 1 shows an exemplary configuration of a database system according to an embodiment of the invention.

FIG. 2 shows an example of data stored in a memory 112 of a computer 101.

FIG. 3 shows an example of data stored in a memory 122 of a storage apparatus 102.

FIG. 4 shows an example of data stored in a memory 132 of a control server 103.

FIG. 5 shows an example of mapping information 2021 stored in the memory 112 of the computer 101.

FIG. 6 shows an example of schema information 2011 for a DBMS 201.

FIG. 7 shows an example of volume management information 301 stored in the memory 122 of the storage apparatus 102.

FIG. 8 shows an example of a query request S801 and processing execution schedule S802 created by the DBMS 201 for handling the query request S801.

FIG. 9 shows an example of processing execution schedule information 2012 stored in the memory 112 of the computer 101.

FIG. 10 shows an example of storage method information 405 stored in the memory 132 of the control server 103.

FIG. 11 is a first flowchart illustrating a data placement determination procedure.

FIG. 12 is a second flowchart illustrating a data placement determination procedure.

FIG. 13 is a flowchart illustrating a data access mode determination procedure.

### DESCRIPTION OF EMBODIMENTS

An embodiment of the invention will be now described, though the invention is not limited by the embodiment. While numbers and/or names are used as identification information for information elements, any other types of identification information may be used.

Although some of the following description is given with a “program” being the agent, a processor may also be the agent because a program carries out predetermined processing using memory and communication ports by being executed by a processor (typically a Central Processing Unit or CPU). Any processing that is disclosed with a program being the agent may also be performed by a computer or information processing apparatus, such as a server or a storage apparatus. Part or all of a program may be implemented by dedicated hardware. Additionally, programs may be installed on a computer via a program distribution server or a computer-readable storage medium.

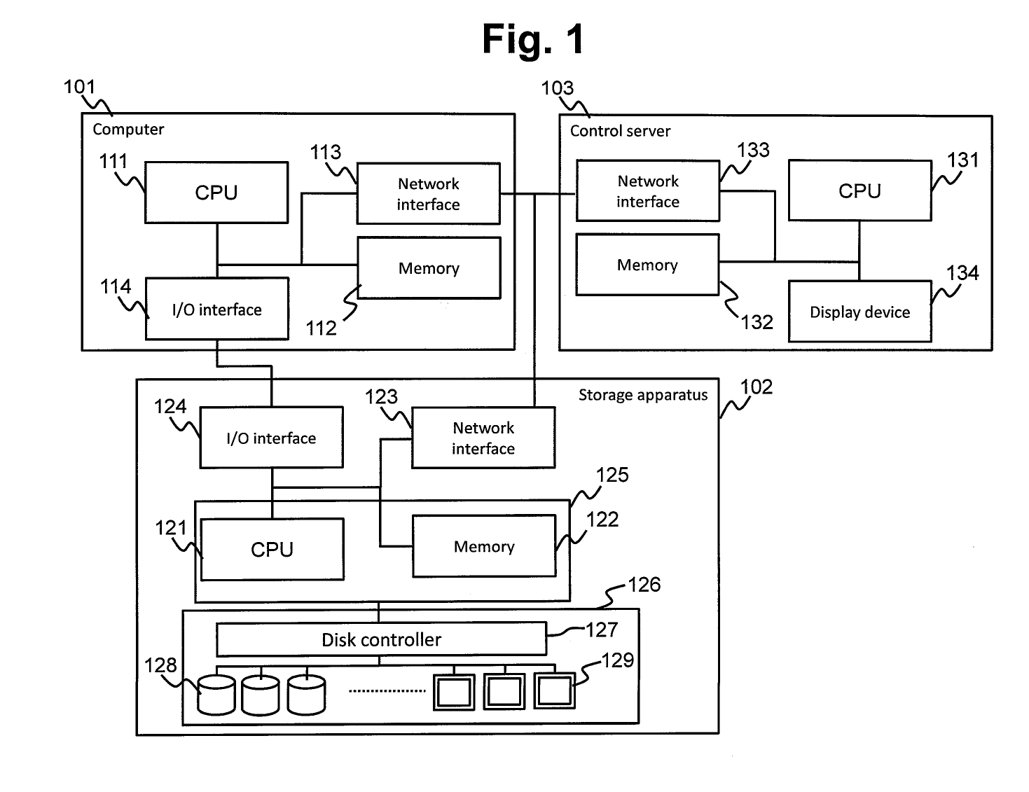

FIG. 1 shows an exemplary configuration of a database system according to the embodiment of the invention.

The database system includes a computer 101, a storage apparatus 102, and a control server 103. The computer 101 and the storage apparatus 102 are coupled to each other via their I/O (Input/Output) interfaces (114, 124). A communication network that couples the I/O interfaces 114 and 124 may be a Storage Area Network (SAN), for example. The computer 101, the storage apparatus 102, and the control server 103 are coupled to each other by their respective network interfaces (113, 123, 133). A communication network that couples the network interfaces 113, 123, 133 may be a Local Area Network (LAN).

The storage apparatus 102 provides storage areas for an external apparatus (e.g., the computer 101). The storage apparatus 102 manages the storage areas in units of logical volumes and provides storage areas in units of logical volumes to the external apparatus. On the storage apparatus 102, management of logical volumes (e.g., access to logical volumes from the external apparatus) is done in units of blocks that make up the logical volumes. In other words, the storage areas making up the logical volumes are managed as multiple blocks.

The storage apparatus 102 includes a network interface 123, an I/O interface 124, a storage controller 125, and a storage part 126, for example. The storage controller 125 is coupled to the I/O interface 124, the network interface 123, and the storage part 126 (a disk controller 127).

The network interface 123 is an interface for communicating with the computer 101 and the control server 103. The I/O interface 124 is an interface for communicating with the computer 101. The storage controller 125 performs write and read of data (e.g., DB data) to and from the storage part 126. The storage controller 125 includes a CPU 121 and a memory 122, for example. The memory 122 stores programs for executing various kinds of processing, information required for the programs, and the like. The CPU 121 carries out various kinds of processing by executing the programs stored in the memory 122 and using the information in the memory 122. The storage part 126 manages DB data. The storage part 126 includes the disk controller 127 and one or more storage units (128, 129).

In this embodiment, the storage apparatus 102 includes one or more magnetic storage units 128 and one or more semiconductor storage units 129 as storage units. The disk controller 127 is coupled to and controls the magnetic storage unit 128 and semiconductor storage unit 129. The magnetic storage unit 128 is a storage unit that stores data by a magnetic storage method, typically an HDD. The semiconductor storage unit 129 is a storage unit that stores data by a semiconductor storage method, typically an SSD.

The computer 101 includes a CPU 111, a memory 112, a network interface 113, and an I/O interface 114. The computer 101 accesses volumes provided by the storage apparatus 102. The network interface 113 is an interface for communicating with the storage apparatus 102 and the control server 103. The I/O interface 114 is an interface for communicating with the storage apparatus 102. The memory 112 stores programs for executing various kinds of processing, information required for the programs, and the like. The CPU 111 carries out various kinds of processing by executing the programs stored in the memory 112 and using the information in the memory 112. That is, the CPU 111 implements various functions.

The control server 103 includes a CPU 131, a memory 132, a network interface 133, and a display device 134. The network interface 133 is an interface for communicating with the computer 101 and the storage apparatus 102. The memory 132 stores programs for executing various kinds of processing, information required for the programs, and the like. The CPU 131 carries out various kinds of processing by executing the programs stored in the memory 132 and using the information from the memory 132. The CPU 131 can control access of the computer 101 to the storage apparatus 102. The CPU 131 can also display information on the display device 134. Instead of having the display device 134, the control server 103 may be able to communicate with a remote apparatus having a display device over a communication network or the like. The act of “displaying” by the CPU 131 (and the control server 103 including the CPU 131) may be either the act of the CPU 131 displaying information such as characters or images on the display device 134 of the control server 103, which includes the CPU 131, or the act of sending display information such as characters or images to a remote apparatus with a display device for display thereon. Upon receiving the display information, the remote apparatus can display characters or screens represented by the information on its display device.

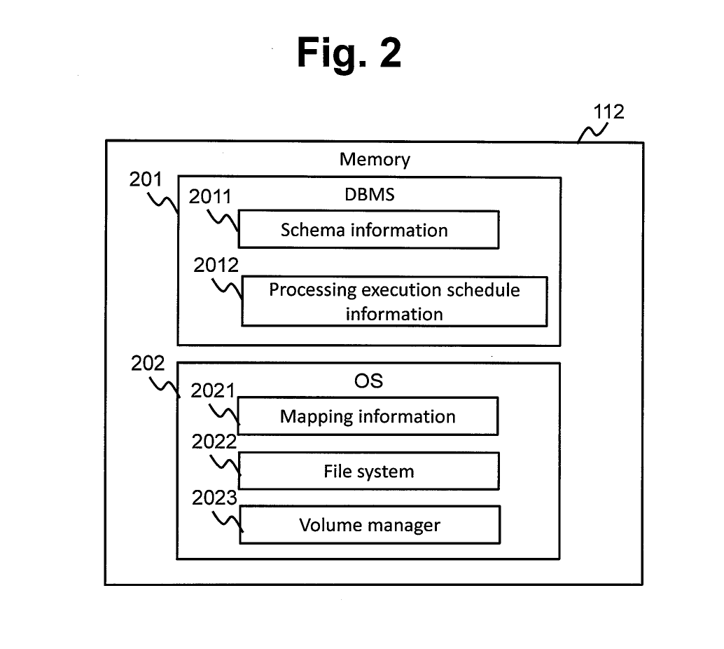

FIG. 2 shows an example of data stored in the memory 112 of the computer 101.

In the memory 112, a DBMS 201 and an Operating System (OS) 202 are stored, for example. By the CPU 111 using information stored in the memory 112, various functions are implemented. The DBMS 201 is a program for managing a database. The DBMS 201 includes schema information 2011 and processing execution schedule information 2012. The schema information 2011 and processing execution schedule information 2012 will be discussed later.

The OS 202 includes mapping information 2021, a file system 2022, and a volume manager 2023. The mapping information 2021 is information used for managing data managed by the DBMS 201 in a file format as well as information used for managing information relating to association between logical volumes and storage areas (volumes) of the storage part 126. The mapping information 2021 will be described in further detail below.

The file system 2022 stores information on the way of creating file folders (directories) in the storage units (128, 129), the way of moving and deleting files in the storage units (128, 129), and the way of storing data in the storage units (128, 129), for example. The volume manager 2023 is a program that sends to the storage apparatus 102 an instruction to prepare logical volumes to be provided for the external apparatus in the storage units (128, 129) or an instruction to prepare logical volumes to be provided to the external apparatus from a RAID (Redundant Arrays of Inexpensive Disks) group of a certain level built on the storage units (128, 129), for example. The OS 202 may have a raw device mechanism, which is a system to allow the DBMS 201 to access via an interface equivalent to that for files.

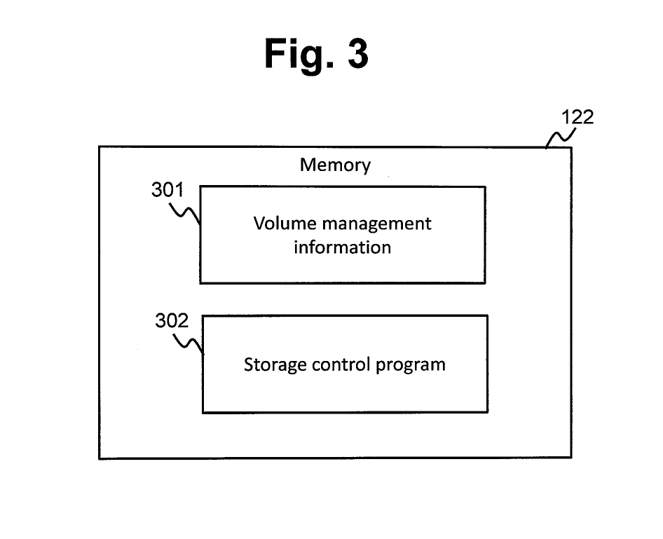

FIG. 3 shows an example of data stored in the memory 122 of the storage apparatus 102.

By the CPU 121 using information stored in the memory 122, various functions are implemented. The memory 122 stores volume management information 301 and a storage control program 302. The volume management information 301 is information used for managing data storage locations in the magnetic storage unit 128 or semiconductor storage unit 129, which physically stores data. The volume management information 301 will be described in further detail below. The storage apparatus 102 (more specifically, the storage controller 125) is capable of relocating data stored in one volume across the magnetic storage unit 128 and the semiconductor storage unit 129, for example. The storage control program 302 controls the entire storage apparatus 102.

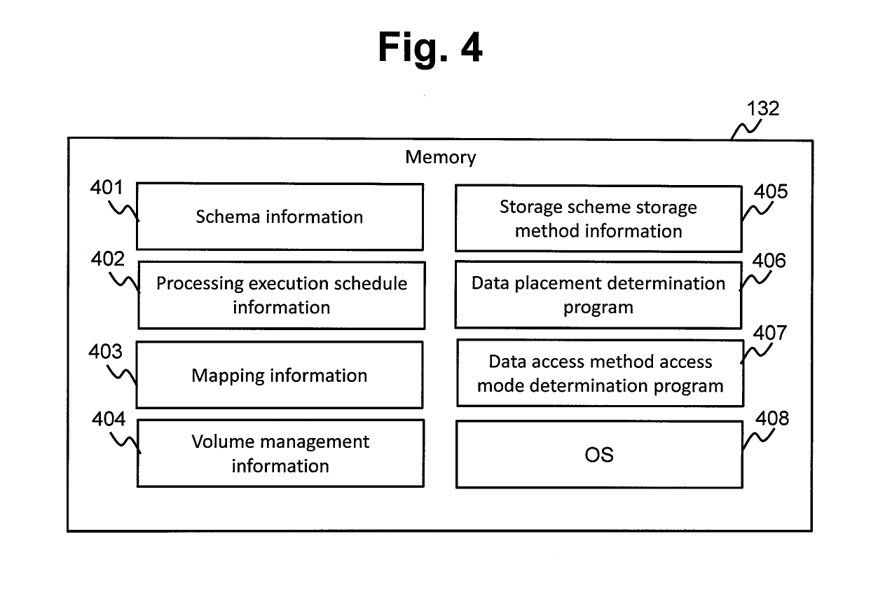

FIG. 4 shows an example of data stored in the memory 132 of the control server 103.

The memory 132 stores schema information 401, processing execution schedule information 402, mapping information 403, volume management information 404, storage method information 405, a data placement determination program 406, a data access mode determination program 407, and an OS 408. The schema information 401 is similar to schema information 2011. The processing execution schedule information 402 is similar to processing execution schedule information 2012. The mapping information 403 is similar to mapping information 2021. The volume management information 404 is similar to volume management information 301. Various functions are implemented by the CPU 131 executing the data placement determination program 406, data access mode determination program 407, and OS 408.

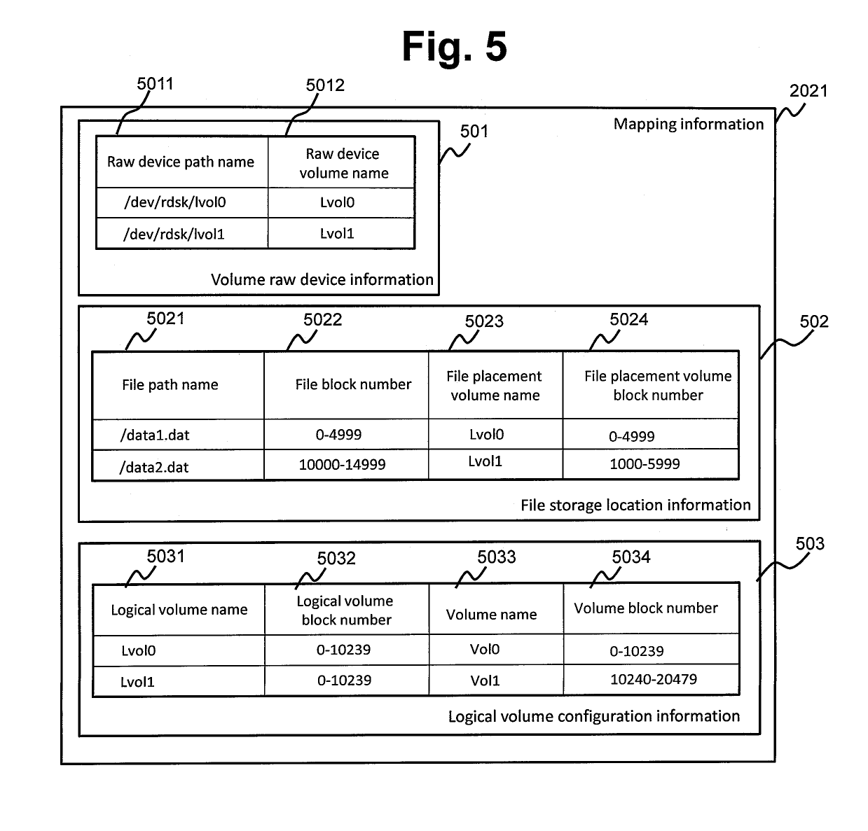

FIG. 5 shows an example of mapping information 2021 stored in the memory 112 of the computer 101.

The mapping information 2021 includes volume raw device information 501, file storage location information 502, and logical volume configuration information 503. The volume raw device information 501 includes fields of raw device path name 5011 and raw device volume name 5012. The raw device path name 5011 stores identifiers (raw device path names) for specifying raw devices within the OS 202. The raw device volume name 5012 stores the identifier (volume name) of a volume (physical volume) or a logical volume that is provided by the storage apparatus 102 and accessed with a raw device path name stored in the raw device path name 5011.

The file storage location information 502 includes a set of fields of file path name 5021, file block number 5022, file placement volume name 5023, and file placement volume block number 5024. The file path name 5021 stores an identifier (file path name) used for the OS 202 to specify a file. The file block number 5022 stores a number (file block number) for specifying the position, within a volume, of data that makes up the file specified by the OS 202. The file placement volume name 5023 stores the identifier (volume name) of a volume or logical volume provided by the storage apparatus 102 in which the data making up the file is stored. The file placement volume block number 5024 stores information (a block number) showing the storage location of data making up the file in the volume or logical volume identified by the volume name stored in the file placement volume name 5023.

The logical volume configuration information 503 includes a set of fields of logical volume name 5031, logical volume block number 5032, volume name 5033, and volume block number 5034. The logical volume name 5031 stores the identifier (logical volume name) of a logical volume that is provided to an upper apparatus by the volume manager 2023. The logical volume block number 5032 stores information (a block number) indicating the storage location of data stored in a logical volume, within the logical volume. The volume name 5033 stores the identifier (volume name) of a physical volume in which the data of the logical volume in the block is stored. The volume block number 5034 stores information (a block number) that shows the storage location of the data stored in the physical volume, within the physical volume. The uppermost entry or row in the logical volume configuration information 503 indicates that data in the block having a block number “0-10239” in a logical volume “Lvo10” is stored in the block having a block number “040239” in a physical volume “Vol0”.

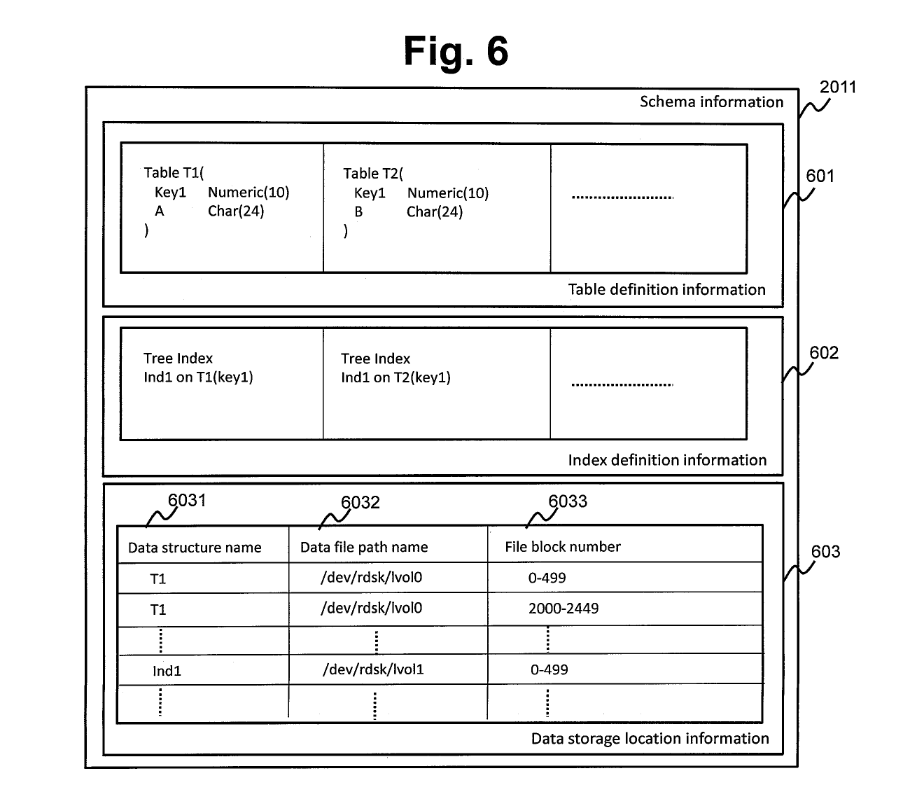

FIG. 6 shows an example of schema information 2011, which is management information for data and the like defined and managed by the DBMS 201.

The schema information 2011 includes table definition information 601 which maintains definition information for table data structures or the like, index definition information 602 which maintains definition information for index data structures and/or tables or the like that are indexed, and data storage location information 603 which maintains the data storage location of managed data, for example.

Data storage location information 603 includes a set of fields of data structure name 6031, data file path name 6032, and file block number 6033. The data structure name 6031 stores the identifier (data structure name) of a data structure, such as a table and index. The data file path name 6032 stores the identifier (file path name) of a file or raw device that stores data of the data structure name stored in the data structure name 6031. By referencing the mapping information 2021 using the file path name, it is possible to identify a volume of a storage unit that stores data of the data structure specified by the data structure name in the data structure name 6031. The file path name and information from the mapping information 2021, used for identifying the storage unit volume, represents an example of volume identifying information. The file block number 6033 stores the storage location (block number), within a file, of data having the data structure name stored in data structure name 6031. For example, the uppermost entry of data storage location information 603 shows that a data structure “T1” is stored in a block “0-499” in a raw device (a file) located at “/dev/rdsk/lvol0”.

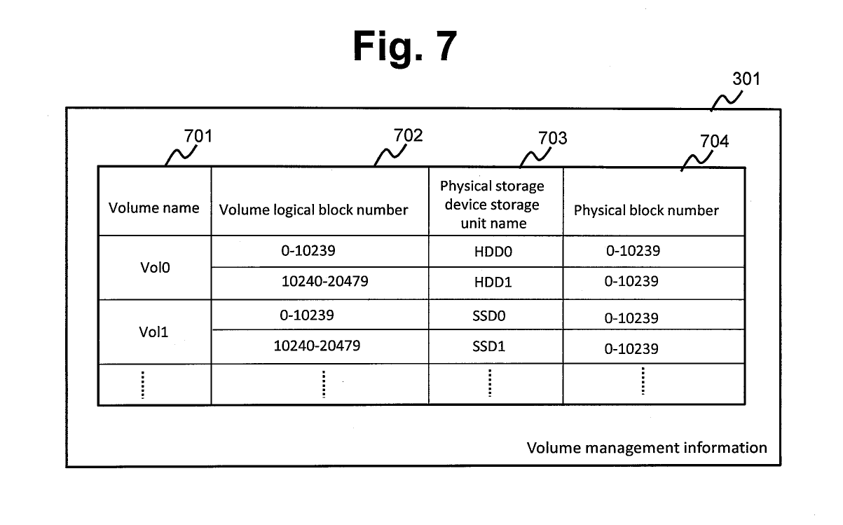

FIG. 7 shows an example of volume management information 301 stored in the memory 122 of the storage apparatus 102.

The volume management information 301 includes fields of volume name 701, volume logical block number 702, physical storage unit name 703, and physical block number 704. The volume name 701 stores information (volume name) identifying a logical volume provided by the storage apparatus 102. The volume logical block number 702 stores the logical storage location (block number) of data in that logical volume. The physical storage unit name 703 stores the identifier (storage unit name) of a physical storage unit that actually stores the data in the logical volume identified by the volume name stored the volume name 701 (i.e., the magnetic storage unit 128 or semiconductor storage unit 129). The physical block number 704 stores the physical storage location (physical block number) within the storage unit that actually stores the data of the logical volume.

The storage control program 302 stored in the memory 122 identifies the storage location of data in a storage unit (the magnetic storage unit 128 or semiconductor storage unit 129) with reference to the volume management information 301 in response to a data read/write request from the computer 101, and executes the read or write request to/from the storage unit (the magnetic storage unit 128 or semiconductor storage unit 129) using the disk controller 127.

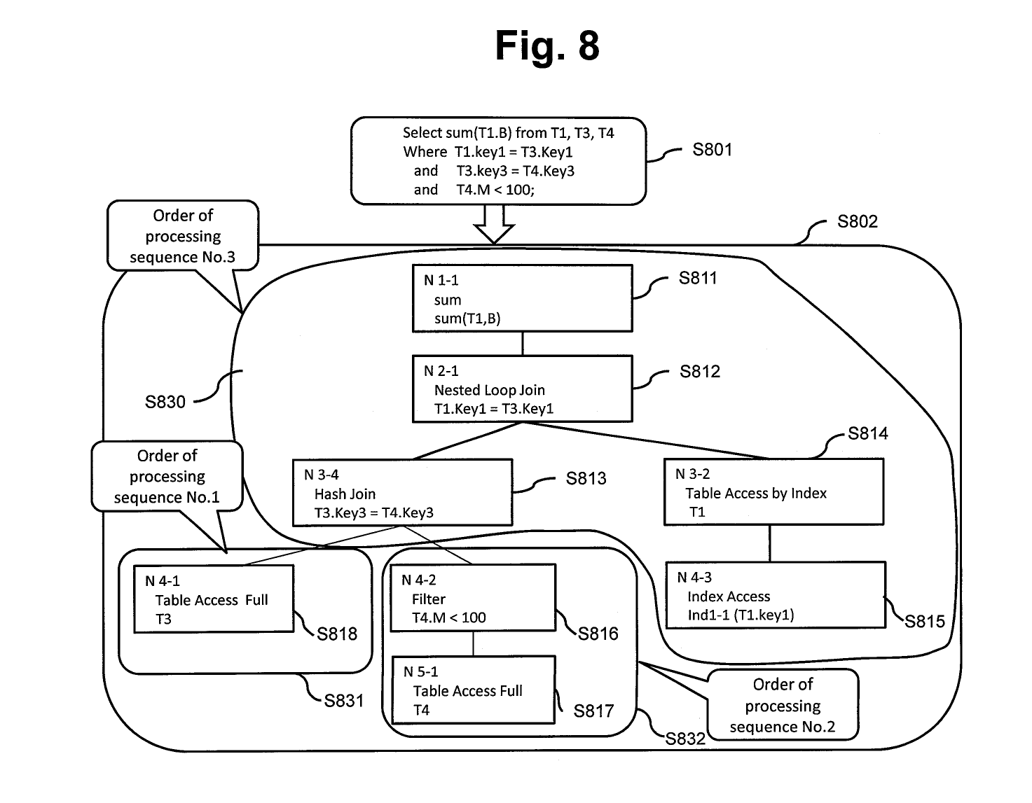

FIG. 8 shows an example of a query request S801 and a processing execution schedule S802 created by the DBMS 201 for handling the query request S801.

Upon receiving a query request S801 written in a Structured Query Language (SQL) statement or the like, the DBMS 201 creates processing execution schedule S802 showing a series of processes that should be internally done for handling the query request S801 and the order of performing them.

As shown in FIG. 8, the processing execution schedule S802 can be represented in a tree structure in which processing nodes represent specific processes to be internally executed in order to obtain the result for the query request S801, for example.

In FIG. 8, processing performed by the DBMS 201 flows from leaves (the lower portion in the drawing) to the root (the upper portion in the drawing). Processing nodes S811, S812, S813, S814, S815, S816, S817, and S818 represent specific processes executed for the query request S801, and lines connecting the processing nodes represent data flow. One or a plurality of processing nodes form a set of processing groups S830, S831, and S832. The processing groups S830, S831 and S832 are each made up of processing nodes that can be processed by the DBMS 201 at the same time. For example, in the processing group S830, the DBMS 201 can process processing nodes S811, S812, S813, S814, and S815 at the same time. The processing groups S830, S831, S832 are each given a processing sequence number showing the order of performing the processing for that group. The processing groups are processed by the DBMS 201 in ascending order of the number. According to the processing execution schedule S802 shown in FIG. 8, processing will be performed in the order of the processing group S831 having the processing sequence number “1”, followed by processing group S832 having the processing sequence number “2”, and then the processing group S830 having the processing sequence number “3”. This order of processing causes data processing performed by the DBMS 201 to flow from leaf nodes toward the root.

The DBMS 201 stores the contents of the processing execution schedule S802 in the memory 112 as processing execution schedule information 2012.

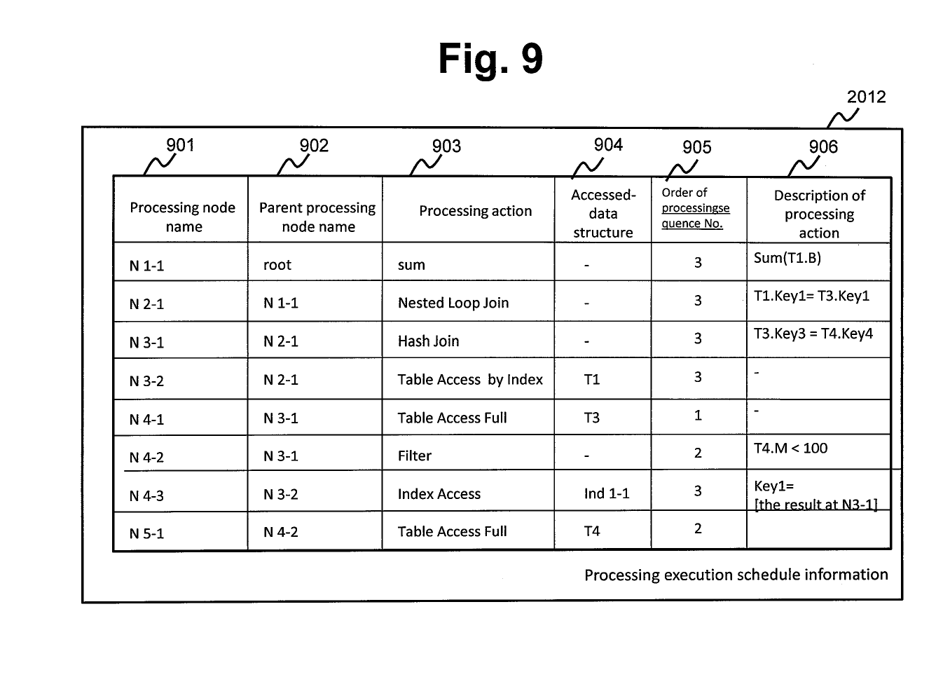

FIG. 9 shows an example of processing execution schedule information 2012 stored in the memory 112 of the computer 101. FIG. 9 illustrates processing execution schedule information 2012 for the case the processing execution schedule S802 shown in FIG. 8 is created.

One processing execution schedule contains multiple processing nodes. At each processing node, processing is executed based on data read from the magnetic storage unit 128 or semiconductor storage unit 129. At each processing node, data is read through either random or sequential access to the magnetic storage unit 128 or semiconductor storage unit 129, and processing is executed based on the data.

The processing execution schedule information 2012 includes a set of fields of processing node name 901, parent processing node name 902, processing action 903, accessed-data structure name 904, processing sequence number 905, and description of processing action 906.

The processing node name 901 stores the identifiers (processing node names) of processing nodes included in a processing execution schedule. The processing node names “N1-1” to “N4-2” stored in the processing node name 901 of FIG. 9 each corresponds to one of the processing nodes S801 to S818 shown in FIG. 8.

Parent processing node name 902 stores the identifier (parent processing node name) of a processing node (parent processing node) that represents the parent of the processing node having the processing node name stored in the processing node name 901. A parent processing node refers to a processing node that is positioned upstream of the processing node identified by the processing node name stored in the processing node name 901 in the flow of processing and that directly exchanges data with (i.e., is directly coupled to) the processing node identified by the processing node name stored in the processing node name 901, for example.

The processing action 903 stores processing actions to be executed at the processing node having the processing node name stored in the processing node name 901. Processing involving access to a storage unit among processing actions stored in the processing action 903 can be classified into one of two categories, “random access” and “sequential access”, according to its nature. For example, a processing action “Table Access Full” can be classified into sequential access and “Table Access by index” can be classified into random access. A processing action stored in the processing action 903 serves as access type information that can identify the type of data access.

The accessed-data structure name 904 stores the identifier (data structure name) of data to be accessed at the processing node having the processing node name stored in the processing node name 901.

The processing sequence number 905 stores a number showing the order of executing the processing node having the processing node name stored in the processing node name 901. Processing nodes having the same value in the processing sequence number 905 belong to the same processing group and are processed by the CPU 111 at the same time. For example, processing nodes with the processing node names “N1-1”, “N2-2”, “N3-1”, “N3-2”, and “N4-3” in the processing node name 901 all have the value (order of processing) of “3” in the processing sequence number 905, so they belong to the same processing group. These processing nodes are processed by the CPU 111 at the same time.

Description of processing action 906 stores specifics of a processing action at the processing node having the processing node name stored in the processing node name 901. For example, a conditional expression for selecting data to be used in processing or the like can be stored in the description of processing action 906.

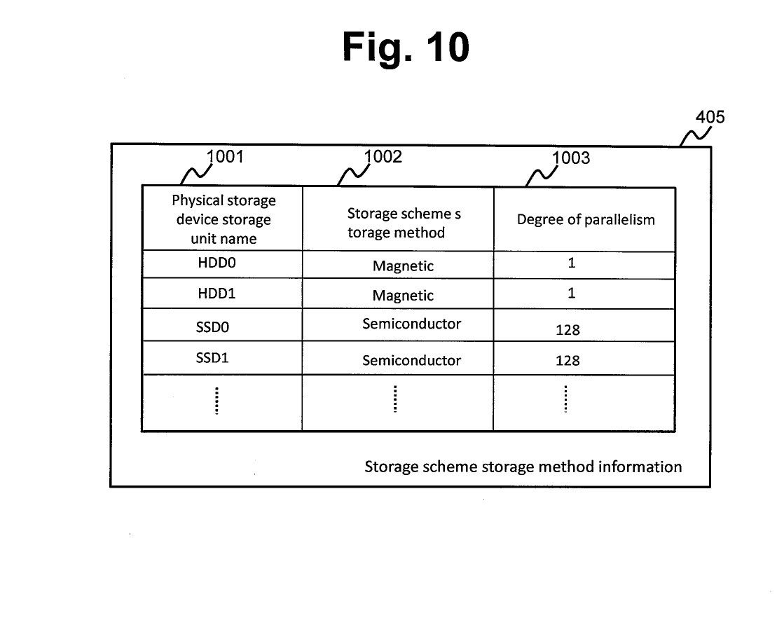

FIG. 10 shows an example of storage method information 405 stored in the memory 132 of the control server 103.

The storage method information 405 includes a set of fields of physical storage unit name 1001, storage method 1002, and degree of parallelism 1003.

The physical storage unit name 1001 stores an identifier (storage unit name) that identifies the magnetic storage unit 128 or the semiconductor storage unit 129. The storage method 1002 stores the storage method of data in the storage unit having the storage unit name stored in the physical storage unit name 1001. The storage method 1002 is configured to “magnetic”, indicating a magnetic storage method, when the storage unit is the magnetic storage unit 128 and “semiconductor”, indicating a semiconductor storage method, when the storage unit is the semiconductor storage unit 129.

The degree of parallelism 1003 stores a degree of parallelism indicating how many I/O requests, such as read and write requests, are processed simultaneously by a storage unit in order to gain good performance when the storage unit having the storage unit name stored in the physical storage unit name 1001 is used. For example, when the storage unit is the semiconductor storage unit 129, a high degree of parallelism can be configured because the disk controller 127 can simultaneously access multiple chips making up the semiconductor storage unit 129.

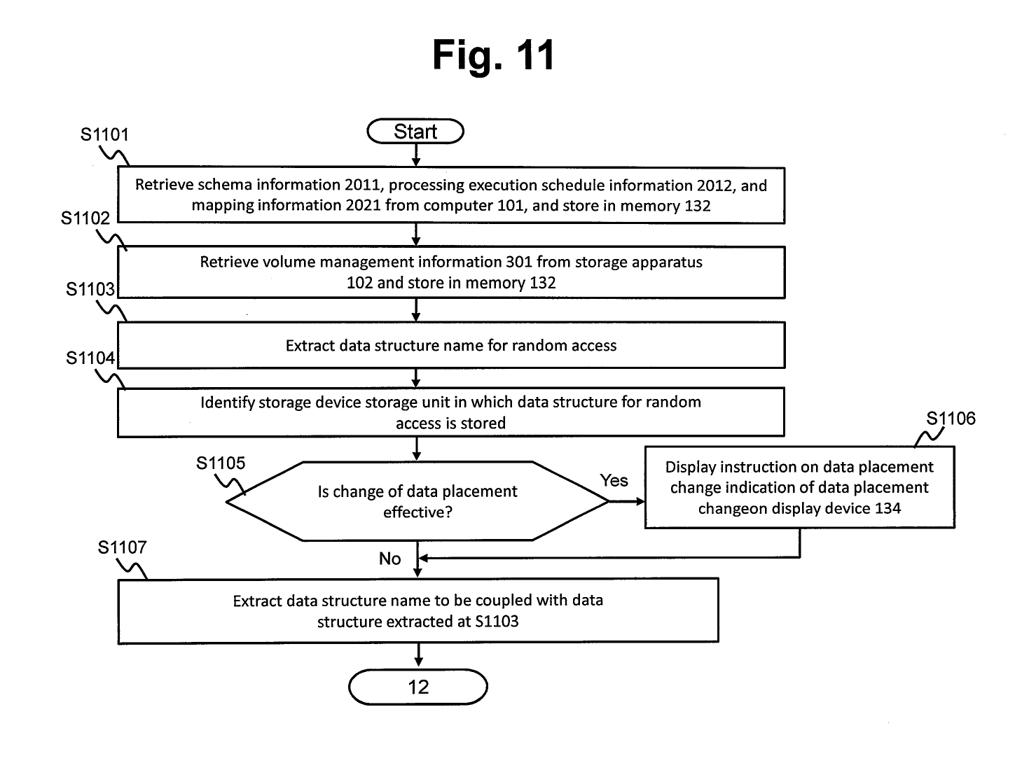

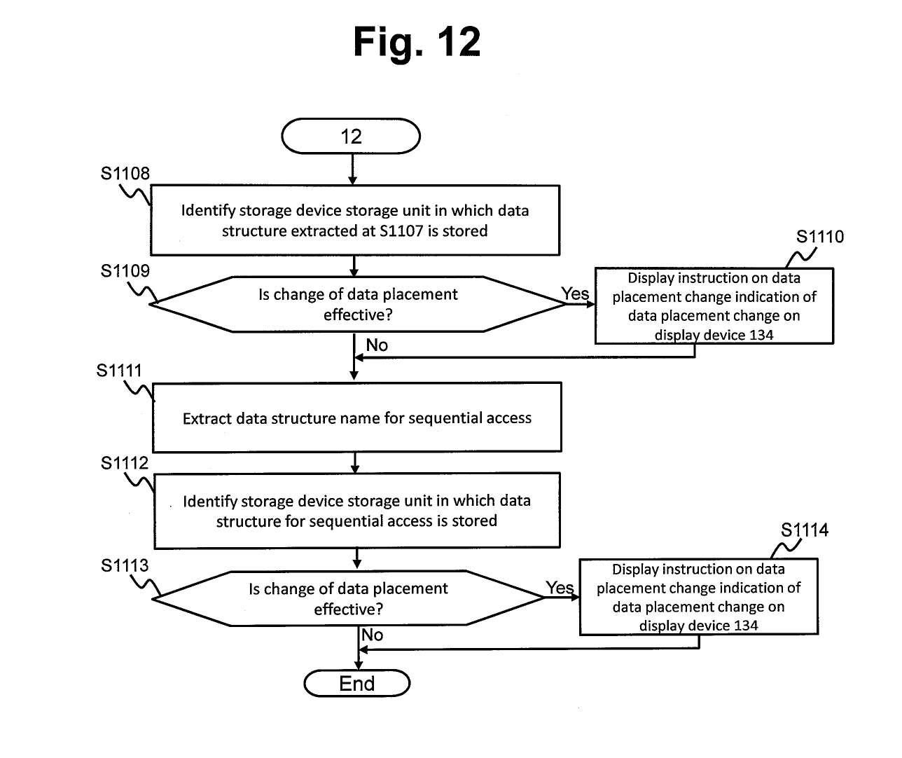

FIG. 11 is a first flowchart illustrating a data placement determination procedure, and FIG. 12 is a second flowchart illustrating a data placement determination procedure. The horizontal ellipse denoted as “12” in the FIG. 11 flowchart corresponds to the horizontal ellipse denoted as “12” in FIG. 12, meaning that the two flowcharts are connected.

The data placement determination procedure is implemented by the CPU 131 of the control server 103 executing the data placement determination program 406. Data placement determination procedure can be executed in response to the control server 103 being informed that a query request from the computer 101 has been accepted, for example.

At step S1101, data placement determination program 406 of the control server 103 retrieves schema information 2011, processing execution schedule information 2012, and mapping information 2021 from the computer 101, and stores them in the memory 132 as schema information 401, processing execution schedule information 402, and mapping information 403, respectively. In this embodiment, the schema information 401, processing execution schedule information 402, and mapping information 403 are the same as schema information 2011 shown in FIG. 6, processing execution schedule information 2012 shown in FIG. 9, and mapping information 2021 shown in FIG. 5, respectively, so the same fields will be described using the reference numbers used in the figures showing the same pieces of information for the sake of convenience.

At step S1102, the data placement determination program 406 retrieves volume management information 301 from the storage apparatus 102 and stores it in the memory 132 as volume management information 404. As the volume management information 404 is the same as the volume management information 301 shown in FIG. 7 in this embodiment, the following description will use the reference numeral used in FIG. 7 for the sake of convenience.

At step S1103, the data placement determination program 406 retrieves the data structure name of a data structure which will be randomly accessed from among processing nodes in the processing execution schedule information 402, for example, with reference to the processing execution schedule information 402. Specifically, the data placement determination program 406 identifies an entry in which the processing action 903 indicates a processing action that involves random access, and retrieves the data structure name of the accessed-data structure name 904 in that entry. A processing action that involves random access can be “Table Access by Index”, for instance.

At step S1104, the data placement determination program 406 determines whether the storage unit storing data having the data structure identified by the data structure name retrieved at step S1103 is the magnetic storage unit 128 or the semiconductor storage unit 129. Specifically, the data placement determination program 406 identifies an entry in which the data structure name in the data structure name 6031 in the data storage location information 603 of schema information 401 is the data structure name retrieved at step S1103, and retrieves the file path name in the data file path name 6032 of that entry. The data placement determination program 406 further identifies the raw device volume name from the raw device volume name 5012 of the entry corresponding to the data file path name within volume raw device information 501 of mapping information 403. The data placement determination program 406 further identifies an entry in which the identified raw device volume name is stored in volume name 701 with reference to the volume management information 404, and identifies the physical storage unit name from the physical storage unit name 703 of that entry.

At step S1105, the data placement determination program 406 determines whether change of data placement will be effective for data of the data structure (target data) that corresponds to the data structure name retrieved at step S1103. Specifically, the data placement determination program 406 checks whether the storage method 1002 of the entry corresponding to the physical storage unit name identified at step S1104 is magnetic or semiconductor with reference to the storage method information 405, for example. If the storage method 1002 is magnetic, it means that the target data is stored in the magnetic storage unit 128, which is based on a magnetic storage method, so the data placement determination program 406 determines that change of data placement is effective. This is because a magnetic storage unit has a low IOPS (Input/Output Per Second) with random access as compared to a semiconductor storage unit, and thus access performance could be improved by moving the target data (data to be randomly accessed), if stored in the magnetic storage unit 128, to the semiconductor storage unit 129. The determination on effectiveness of data placement change at step S1105 is equivalent to determining whether access performance will increase after data relocation. If the storage method 1002 is semiconductor, it means that the target data is stored in the semiconductor storage unit 129, which is based on a semiconductor storage method, so the data placement determination program 406 determines that change of data placement is not effective.

If it determines that change of data placement is effective (step S1105: Yes), the data placement determination program 406 passes control to step S1106; whereas if it determines that change of data placement is not effective (step S1105: No), it passes control to step S1107.

At step S1106, the data placement determination program 406 decides that the target data should be moved from the magnetic storage unit 128 to the semiconductor storage unit 129, displays an indication to move the target data from the magnetic storage unit 128 to the semiconductor storage unit 129 on the display device 134, and then passes control to step S1107. The indication of moving the target data from the magnetic storage unit 128 to the semiconductor storage unit 129 may contain information that can identify the target data (i.e., data structure name).

At step S1107, the data placement determination program 406 extracts the data structure name of the data structure to be joined to the data structure having the data structure name obtained at step S1103. Specifically, the data placement determination program 406 identifies the parent processing node stored in the parent processing node name 902 in processing execution schedule information 402, identifies the entry corresponding to that parent processing node in the processing execution schedule information 402, and extracts the data structure name of the data structure to be joined to the data structure having the data structure name obtained at step S1103 by making reference to the processing action 903, description of processing action 906 and the like of that entry.

The following process will be described on the assumption that two data structure names are extracted for the data structure at step S1107. For a data structure, one, or three or more data structure names can be extracted.

At step S1108, the data placement determination program 406 identifies the storage unit storing the data structures having the data structure names extracted at step S1107. The storage unit is identified from a data structure name in the manner described at step S1104.

At step S1109, the data placement determination program 406 determines whether changing the placement of data of the data structures having the data structure names extracted at step S1107 will be effective. Specifically, if one of the two data structures to be joined is placed in the magnetic storage unit and the other is in the semiconductor storage unit, the data placement determination program 406 determines that relocation of the data structure stored in the magnetic storage unit to the semiconductor storage unit will be effective, for example. That is, the data placement determination program 406 determines here that placement of both the data structures in the semiconductor storage unit is effective. The determination on effectiveness of data placement change at step S1109 is substantially the same as step S1105. At step S1109, the data placement determination program 406 may change the way of determination depending on how to join two data structures, e.g., nested loop join or hash join. If it determines that change of data placement is effective (step S1109: Yes), the data placement determination program 406 passes control to step S1110; whereas if it determines that change of data placement is not effective (step S1109: No), it passes control to step S1111.

At step S1110, the data placement determination program 406 decides that data of the data structure for which change of data placement has been determined to be effective should be moved from the magnetic storage unit 128 to the semiconductor storage unit 129, has an indication of moving the data from the magnetic storage unit 128 to the semiconductor storage unit 129 be displayed on the display device 134, and then passes control to step S1111.

At step S1111, the data placement determination program 406 extracts the data structure name of the data structure that will be sequentially accessed with reference to the processing execution schedule information 402. Specifically, the data placement determination program 406 identifies an entry in which the processing action 903 is a processing action involving sequential access, and retrieves the data structure name from the accessed-data structure name 904 of that entry. A processing action that involves sequential access can be “Table Access full”, for instance.

At step S1112, the data placement determination program 406 identifies the storage unit storing data of the data structure with the data structure name that will be sequentially accessed. The process at step S1112 is substantially the same as the process at step S1104 except for difference in data of the target data structure.

At step S1113, the data placement determination program 406 determines whether change of data placement is effective for data of the data structure having the data structure name extracted at step S1111. Specifically, the data placement determination program 406 checks whether the storage method 1002 corresponding to the physical storage unit name identified at step S1112 is magnetic or semiconductor, with reference to storage method information 405. If the storage method 1002 is semiconductor, it means that data of the data structure that will be sequentially accessed is stored in the semiconductor storage unit 129, thus it is determined that change of data placement is effective. Although the throughput (MB/s) for sequential access to a magnetic storage unit is low compared to a semiconductor storage unit, they are not significantly different. Meanwhile, the magnetic storage unit is lower in per-bit cost than the semiconductor storage unit. Thus, when data of a data structure that is sequentially accessed is stored in the semiconductor storage unit 129, cost performance would be increased by placing data of the data structure in the magnetic storage unit 128. The determination on effectiveness of data placement change at step S1113 is equivalent to determining whether cost performance will increase through data relocation. If the storage method 1002 is magnetic, it means that the target data is stored in the magnetic storage unit 128, thus the data placement determination program 406 determines that change of data placement is not effective.

If it determines that change of data placement is effective (step S1113: Yes), the data placement determination program 406 passes control to step S1114; whereas if it determines change of data placement is not effective (step S1113: No), it terminates the process.

At step S1114, the data placement determination program 406 decides that the data of the data structure for which change of data placement has been determined to be effective should be moved from the semiconductor storage unit 129 to the magnetic storage unit 128, has the display device 134 display an indication of moving the data from the semiconductor storage unit 129 to the magnetic storage unit 128, and terminates the process.

As described above, this embodiment can appropriately determine where to relocate DB data based on the type of access to data of a certain data structure, such as random or sequential access, as well as on the storage method of storage units.

In general, a magnetic storage unit has high performance in sequential access but low performance in random access. A feature of the semiconductor storage unit is high random access performance. Additionally, the magnetic storage unit is less expensive than the semiconductor storage unit.

This embodiment identifies the mode of access to data of a data structure and a data structure to be joined to that data structure. When the mode of access is random access and the data of the data structure is stored in a magnetic storage unit, this embodiment decides that the data of the data structure should be moved from the magnetic storage unit to a semiconductor storage unit, which provides higher random access performance, and displays an indication to that effect.

When the mode of access is sequential access and the data of the data structure is stored in a semiconductor storage unit, this embodiment decides that the data of the data structure should be moved from the semiconductor storage unit to a magnetic storage unit, which is less expensive and higher in sequential access performance, and displays an indication to that effect.

This embodiment can order relocating data of a data structure and a data structure to be joined to the data structure to a storage location appropriate for the mode of access to them. Thus, the data can be managed in an appropriate location by relocating it as ordered. This embodiment also orders active use of a magnetic storage unit when data of interest is sequentially accessed, resulting in favorable cost performance.

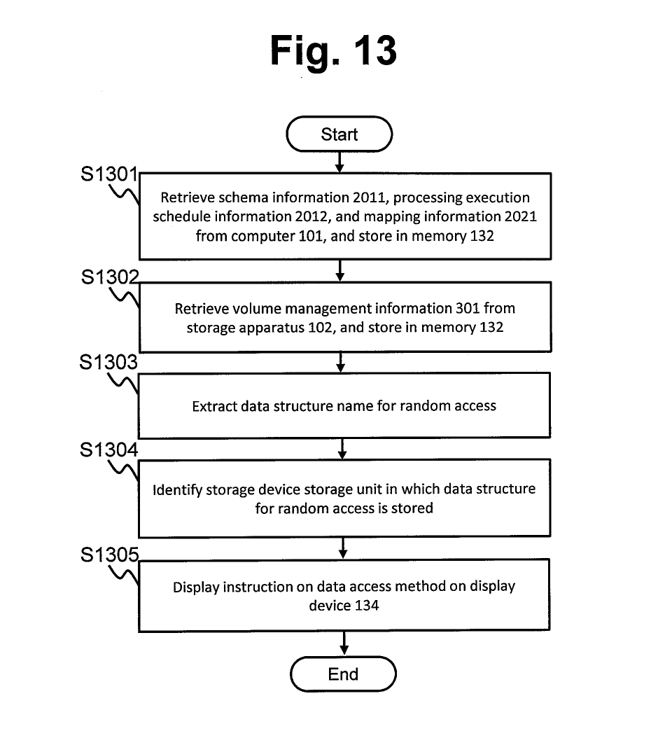

FIG. 13 is a flowchart illustrating data access mode determination procedure.

The data access mode determination procedure is implemented by the CPU 131 of the control server 103 executing the data access mode determination program 407. The data access mode determination procedure is carried out in response to the control server 103 being informed that a query request from the computer 101 has been accepted, for example.

The data access mode determination procedure determines a preferred degree of parallelism at which data of a data structure stored in the storage units 128, 129 should be accessed. The processes at step S1301, step S1302, step S1303, and step S1304 of the data access mode determination procedure are substantially the same as step S1101, step S1102, step S1103, and step S1104 of the data placement determination procedure.

At step S1305 of the data access mode determination procedure, the data access mode determination program 407 displays an indication of the mode of access to data of the data structure to be randomly accessed on the display device 134. Specifically, the data access mode determination program 407 identifies the degree of parallelism, which is the value of the degree of parallelism 1003 in an entry corresponding to the physical storage unit name identified at step S1304, with reference to storage method information 405, for example.

The data access mode determination program 407 then determines the number of I/O commands that will be processed (i.e., how much DB data will be accessed) simultaneously in the storage unit based on the degree of parallelism determined, and displays an indication of the same on the display device 134. The data access mode determination program 407 may show the total degree of parallelism on the display device 134 or the total degree of parallelism less a predetermined value on the display device 134. The total degree of parallelism refers to the sum of degrees of parallelism 1003 for all of multiple storage units across which the target data is stored, for example. The predetermined value may be a value reflecting the years of use of a storage unit, for example.

When volumes are made of one storage unit, the data access mode determination program 407 checks the degree of parallelism for the storage unit and displays an indication prompting the user to configure access to DB data based on the degree of parallelism on the display device 134.

As shown above, the embodiment gives an instruction to appropriately configure the degree of access parallelism for the semiconductor storage unit to allow the user to recognize a proper degree of access parallelism and improve the access performance of the DBMS by configuration according to the instruction. The embodiment can determine the mode of access to data stored in each one storage unit as appropriate for its storage method.

While the embodiment of the invention has been described, the scope of right of the invention is not limited thereto: any form of practice with modification to the invention implemented as the embodiment without losing identity falls within the scope of right of the invention.

For example, in the above description, the data placement determination program 406 displays an indication of data placement change on the display device 134 at step S1106, S1110, and S1114. Alternatively, the storage apparatus 102 may have the function of changing data placement (see Patent Literature 1, for instance) in accordance with the indication on data placement change so that the data placement determination program 406 provides an indication on data placement change to the storage apparatus 102, which then changes data placement in accordance with the indication. This can automatically place data in an appropriate location.

In addition, the data access mode determination program 407 displays an indication of data access mode on the display device 134 at step S1305. Alternatively, the DBMS 201 may be configured to perform data access in accordance with an indication of data access mode, and the data access mode determination program 407 may provide an instruction on data access mode to the DBMS 201. In the case an indication is provided to the DBMS 201, the DBMS 201 may be notified of the number of processing threads which will execute read requests for DB data, as a parameter determining the degree of data access parallelism, for example. The DBMS 201 will then generate processing threads in accordance with the notified number of processing threads.

Additionally, instead of displaying the degree of data access parallelism as data access mode at step S1305, the data access mode determination program 407 may also display the degree of parallelism and a data access size on the display device 134.

### REFERENCE SIGNS LIST

101 . . . computer, 102 . . . storage apparatus, 103 . . . control server

1. A database management method for a database system comprising:
a storage apparatus including a plurality of types of storage units that use different storage methods for storing data;
a computer configured to manage a database by storing data to be managed with the database in storage areas of the storage units of the storage apparatus; and
a control server coupled to the storage apparatus and the computer,
wherein a storage device of the control server has stored therein storage method information that identifies the storage method of the storage units of the storage apparatus,
the method comprising:
(A) acquiring, from the computer, volume identifying information capable of identifying a volume that stores database data to be accessed during processing for a query request to the database, and access type information that is capable of identifying a type of access to the data;
(B) acquiring, from the storage apparatus, volume management information that is capable of identifying the storage unit that stores the volume;
(C) identifying the volume of the data that is to be accessed during processing for the query request based on the volume identifying information, identifying the storage unit that stores the identified volume based on the volume management information, and identifying the storage method of the storage unit based on the storage method information;
(D) identifying the type of access to the data that is to be accessed during processing for the query request, based on the access type information;
(E) determining whether the data needs to be moved to another storage unit of a different storage method, based on the storage method identified in (C) and the type of access identified in (D); and
(F) giving an indication of moving the data to another storage unit of a different storage method if it is determined in (E) that the data needs to be moved to another storage unit of a different storage method.

2. A database management method according to claim 1, further comprising displaying the indication of moving the data to another storage unit of a different storage method.

3. A database management method according to claim 1, further comprising sending the indication of moving the data to another storage unit of a different storage method, to the storage apparatus.

4. A database management method according to claim 2, wherein the access type information comprises information that shows whether the data is accessed by random access or sequential access.

5. A database management method according to claim 4, wherein the plurality of types of storage units include magnetic storage units that store data by a magnetic storage method and semiconductor storage units that store data by a semiconductor storage method.

6. A database management method according to claim 5, further comprising:
determining that the data needs to be moved to a semiconductor storage unit if in (E) the type of access identified in (D) is random access and the storage method identified in (C) is a magnetic storage method; and
displaying an indication of moving the data to the semiconductor storage unit in (F).

7. A database management method according to claim 5, further comprising:
determining that the data needs to be moved to a magnetic storage unit if in (E) the type of access identified in (D) is sequential access and the storage method identified in (C) is a semiconductor storage method; and
displaying an indication of moving the data to the magnetic storage unit.

8. A database management method according to claim 6,
wherein the access type information is processing for the query request, and includes a data structure to be accessed and a processing action that is capable of identifying the type of access to the data structure, and
wherein the volume identifying information includes correspondence between a data structure in which data of the database is managed, a path indicating a location at which the data structure is stored, and identification information for a volume that corresponds to the path.

9. A database management method according to claim 1, wherein the storage method information includes a degree of parallelism that shows a level of parallel access allowed for each of the storage units, the method further comprising:
(F) identifying the degree of parallelism for the storage unit that stores the volume identified in (C) based on the storage method information; and
(G) determining a number of I/O commands that are to be simultaneously processed with accesses to the data based on the degree of parallelism, and providing information on the number of simultaneously-processed I/O commands.

10. A database system comprising:
a storage apparatus including a plurality of types of storage units that use different storage methods for storing data;
a computer configured to store data to be managed with a database in storage areas of the storage units of the storage apparatus, and manage access to the data managed in the database; and
a control server coupled to the storage apparatus and the computer,
wherein the control server includes a storage device and a control device,
wherein the storage device has stored therein storage method information that identifies the storage method of the storage units of the storage apparatus, and
wherein the control device is configured to:
(A) acquire, from the computer, volume identifying information capable of identifying a volume that stores database data to be accessed during processing for a query request to the database, and access type information that is capable of identifying a type of access to the data;
(B) acquire, from the storage apparatus, volume management information that is capable of identifying the storage unit that stores the volume;
(C) identify the volume of the data that is to be accessed during processing for the query request based on the volume identifying information, identifies the storage unit that stores the identified volume based on the volume management information, and identifies the storage method of the storage unit based on the storage method information;
(D) identify the type of access to the data that is to be accessed during processing for the query request, based on the access type information;
(E) determine whether the data needs to be moved to another storage unit of a different storage method, based on the storage method identified in (C) and the type of access identified in (D); and
(F) give an indication of moving the data to another storage unit of a different storage method if it is determined in (E) that the data needs to be moved to another storage unit of a different storage method.

11. A database system according to claim 10, wherein the control device is configured to display the indication of moving the data to another storage unit of a different storage method.

12. A database system according to claim 10, wherein the control device is configured to send the indication of moving the data to another storage unit of a different storage method, to the storage apparatus.

13. A database system according to claim 11,
wherein the access type information comprises information that shows whether the data is accessed by random access or sequential access, and
wherein the plurality of types of storage units include magnetic storage units that store data by a magnetic storage method and semiconductor storage units that store data by a semiconductor storage method.

14. A database system according to claim 13, wherein the control device is configured to:
determine that the data needs to be moved to a semiconductor storage unit if in (E) the type of access identified in (D) is random access and the storage method identified in (C) is magnetic storage method; and
display an indication of moving the data to the semiconductor storage unit in (F).

15. A database system according to claim 13, wherein the control device is configured to:
determine that the data needs to be moved to a magnetic storage unit if in (E) the type of access identified in (D) is sequential access and the storage method identified in (C) is semiconductor storage method; and
display an indication of moving the data to the magnetic storage unit.
